(19) United States
(12) Patent Application Publication
(10) Pub. No.: US 2007/0251786 A1
(43) Pub. Date: Nov. 1, 2007

(54) Wire-winding device for earphones, especially hands free kits for mobile phones

(76) Inventor: Harald Wegner, Frankfurt (DE)

Correspondence Address: STRIKER, STRIKER & STENBY, 103 EAST NECK ROAD, HUNTINGTON, NY, 11743, US

(21) Appl. No.: 11/412,655

(22) Filed: Apr. 27, 2006

(51) Int. Cl. H02G 11/02

(52) U.S. Cl. 191/12.2 R

(57) ABSTRACT

The invention relates to a wire-winding device for earphones, especially for a hands free kit for mobile phones. The wire-winding device comprises a wire-winding unit (50) with a rotary cylindrical wire-winding body (20) for winding up an earphone wire which is pretensioned in a direction of rotation in which the earphone wire will continue to be wound onto the wire-winding body (20) and a housing (1, 45; 60, 65) for accommodation of the wire-winding unit (50) with the wound up earphone wire and the pretensioned wire-winding body (20).

To enable the easy replacement of an earphone or earphone wire, the wire-winding unit (50) is designed according to the invention such that the earphone wire is replaceable with the wire-winding body (20) pretensioned. The wire-winding unit is removed from a housing or the housing is opened in order to replace an earphone. A wire clamping area is then freely accessible from which an earphone wire can be removed after unwinding and can be replaced with a different earphone wire. The wire-winding body is locked in the completely unwound state to prevent unintentional rewinding.

### FIELD OF THE INVENTION

The present invention relates to a wire-winding device for earphones, especially for a hands free kit for mobile phones.

### BACKGROUND OF THE INVENTION

A hands free kit for mobile phones usually comprises one or two earphones, a wire with a connector attached to it for connection to the mobile phone and a microphone, usually with clip, which is provided on the wire. Comparable earphones are available for a series of other electronic appliances, for example for mobile stereo cassette recorders, mobile CD players, mobile-MP3 players and the like, and may include one or two earpieces for insertion into the ear. Such earphones enable mobile use of electronic appliances, for example when walking, running, driving a car or working. For all these uses there must be an adequate length of wire available which frequently leads to undesirable tangling of the wire.

To prevent such tangling of the wire German Utility Model DE 296 21 717 U1 discloses a wire-winding device for the wire of a hands free kit with a housing and a wire winding unit provided within said housing which comprises a pivotable cylindrical wire-winding body for winding up the wire. The wire-winding body is pretensioned by means of a torsion or spiral spring in a direction of rotation in which the wire is further wound onto the wire-winding body. The wire is permanently attached to the wire-winding device with the result that different wire-winding devices have to be manufactured, stocked and sold for different types of hands free kits. This unnecessarily increases the manufacturing and sales costs. It is also not possible for the same wire-winding device to be used for different electronic appliances, such as a mobile phone and a mobile data play-back appliance.

Further wire-winding devices, which are designed expressly for specific applications, are disclosed in the following German Patent or Utility Model applications: DE 20 2004 011 010 U1, DE 20 2004 014 202 U1, DE 2004005 833 U1, DE 298 13 079 U1, DE 202 05 121 U1, DE 201 202-15 U1, DE 201 19 860 U1 and DE 198 47 143 A1. Further wire-winding devices predominantly for stationary applications are disclosed in the U.S. Pat. No. 5,489,010, U.S. Pat. No. 5,544,836, U.S. Pat. No. 5,723,815, U.S. Pat. No. 6,578,683 B1, U.S. Pat. No. 6,623,294 B2 and U.S. Pat. No. 6,626,389 B2. These wire-winding devices are not suitable for joint use with different types of earphones.

A multi-function wire rewinder is disclosed in German Utility Model DE 20 2004 001 604 U1. To design the wire rewinder for different technical functions, the lower part of the housing can be combined with functional elements for realizing said different technical functions, especially with USB ports, card readers, sockets, cooling fans, radio transmitters and such like. This wire rewinder is not suitable for use for earphones or hands free kits for mobile phones already purchased by the user.

U.S. Pat. No. 6,803,525 B1 discloses a wire-winding device. In the cylindrical housing a wire winding unit is provided with a cylindrical wire-winding body with an upper and a lower winding flange. A torsion spring, one end of which is actively joined to the wire-winding body, and the other end of which is actively joined to the housing, is provided for pretensioning of the wire-winding body. To assemble the wire-winding device, the wire must first of all be suitably wound and then the torsion spring for pretensioning of the wire-winding body must be suitably hooked in. There is no provision for subsequent replacement of the wire and this is also impossible unless the torsion spring is unhooked. Therefore, the wire-winding device is not suitable for easy replacement of the wire, i.e. for being used for a different earphone.

### SUMMARY OF THE INVENTION

The object of the present invention is to provide a wire-winding device for earphones, especially for hands free kits of mobile phones, with which it is possible to replace the earphone or the earphone wire in a simple manner.

According to the present invention there is provided a wire-winding device wherein the wire-winding unit is designed such that the earphone wire can be replaced with the wire-winding body pretensioned or biased. Thus one and the same wire-winding device can be used for different types of earphones. In this case replacement can be undertaken by the user himself without the wire-winding unit having to be taken apart and re-assembled after replacement of the wire and/or without the necessity to unhook a torsion spring pretensioning (biasing) the wire-winding body and without the necessity to hook it back in after replacing the wire. The wire-winding device according to the invention can therefore be sold as an accessory independently of the earphone itself and replacement or insertion of the earphone wire can be undertaken by the user himself.

Expediently, the wire-winding body has a wire clamping area for clamping the earphone wire. This clamping area can be formed by a clamping element on the outer circumference of the wire-winding body or more preferably by a channel-type wire guidance area formed by axially protruding walls of the wire-winding body. Expediently, the housing and/or the wire-winding unit is designed such that the earphone wire can be removed from the aforementioned clamping area in a completely unwound rotary position of the wire-winding body and a different earphone wire can be inserted and again be clamped by it. Thus there is no need for tedious unthreading of the earphone wire. The new earphone wire can also be inserted into the clamping area in an essentially stretched form and can be clamped by it.

So that the wire clamping area is accessible in a suitable manner for replacement of the earphone wire, a removable cover may be provided on the housing and/or adjustable, especially hinged or pivotable, housing sections can be provided which expose the wire inlet area and the wire outlet area of the wire-winding device for replacement of the earphone wire and conceal it again after replacement so that the wire cannot be removed or fall out unintentionally.

According to a further embodiment, the wire-winding unit together with the pretensioned wire-winding body is accommodated in the housing so as to be radially displaceable and replacement of the earphone wire is then prevented if the wire-winding unit is completely accommodated within the housing. This function can be accomplished by means of appropriate design of elements of the wire-winding unit and the housing, for example in that the wire inlet area and/or wire outlet area, which circumferentially surrounds the incoming wire, is or are formed by the reciprocation of sections of the wire-winding unit and sections of the housing.

According to a further, preferred embodiment, the wire-winding unit together with the pretensioned wire-winding body can be taken out of the housing completely. This enables replacement of the wire with the wire-winding unit removed. It is advantageous if replacement of the wire is not prevented or hampered by sections of the housing.

In this regard it can be expedient to provide on the housing and/or the wire-winding unit a latching mechanism for detachably securing the wire-winding unit in the housing. Such a latching mechanism can be formed by reciprocating latching elements or by a detachable locking mechanism. According to a further embodiment, the aforementioned securing function can be exercised by a clip element, expediently under elastic deformation of sections of the housing and/or the wire-winding unit.

According to a further embodiment, a locking element is also provided for detachably locking the rotary movement of the wire-winding body which may be in discrete or arbitrary rotary positions of the wire-winding body. Thus it is possible to reliably prevent the wire from being rewound unintentionally, for example during use of the wire-winding device according to the invention or during replacement of the wire, especially in order to reliably insert the wire into the aforementioned wire clamping area.

In this case the locking mechanism can be formed by reciprocation of the housing with the wire-winding unit, for example in such a way that a movable locking pawl is provided on the housing and a wheel with latching teeth reciprocating with said locking pawl is provided on the wire-winding body.

According to a further embodiment, the locking mechanism is formed completely within the wire-winding unit. This makes it easier to completely remove the wire-winding unit with the wire-winding body pretensioned or biased. In this case the locking mechanism conveniently locks the wire-winding body even with the wire-winding unit in the removed state.

According to a further embodiment, which can also be claimed by an independent claim, the wire-winding unit includes a torsion spring for pretensioning the wire-winding body, one end of which is actively joined to a floor of the wire-winding unit and the other end of which is actively joined to the wire-winding body. Thus the whole wire-winding unit can be taken out of the housing without having to unhook the torsion spring. This makes it simple to easily replace the wire in the removed state.

### BRIEF DESCRIPTION OF THE DRAWINGS

The invention will be described in the following by way of example and with reference to the accompanying drawings from which further features, advantages and objects to be solved will become apparent and wherein:

FIG. 1 shows a perspective exploded view of a wire-winding device according to a first embodiment of the present invention;

FIGS. 2a-2 show a top view, a perspective top view, a bottom view and a side view of the wire-winding device according to FIG. 1;

FIGS. 3a-3c show a top view, a bottom view and a perspective top view of the base of the wire-winding unit according to FIG. 1;

FIG. 4 shows a perspective exploded view of a wire-winding device according to a second embodiment of the present invention;

FIGS. 5a-5b show a perspective view of the two housing shells according to FIG. 4;

FIG. 6 shows a perspective view of the wire-winding mechanics with a support frame and wire reel;

FIG. 7 shows the wire-winding device according to FIG. 4 with fully opened housing shells;

FIG. 8 shows a perspective top view of the wire-winding device according to FIG. 4 without the small housing shell; and

FIG. 9 shows a perspective top view of the wire-winding device according to FIG. 4 with the housing shells shut and with the earphone wire inserted.

Identical reference numbers in the Figures refer to elements or element groups which are identical or have essentially the same function.

### DETAILED DESCRIPTION OF PREFERRED EXEMPLARY EMBODIMENTS

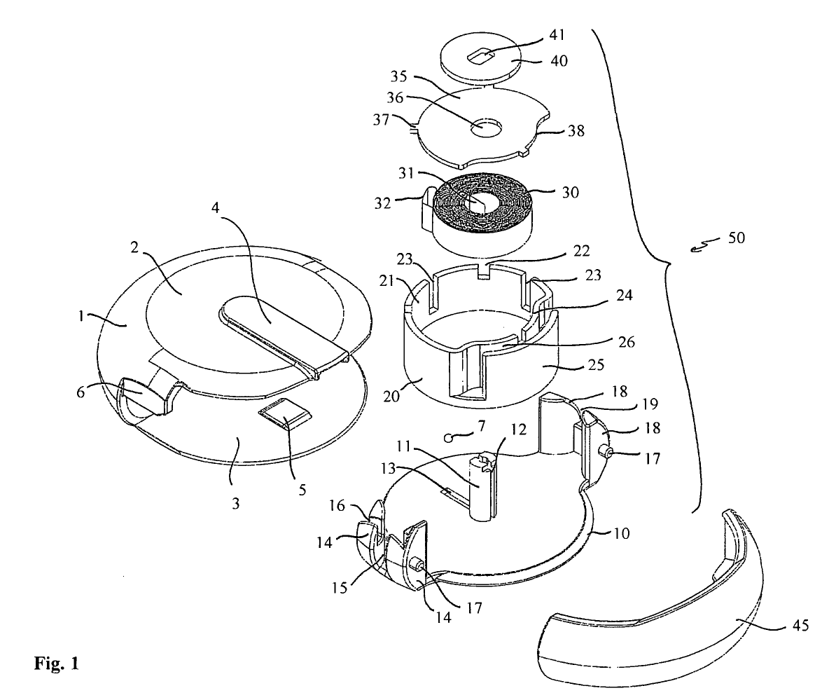

According to FIG. 1 the wire-winding device comprises a housing 1 in which the wire-winding unit referred to overall as 50 is accommodated so as to be removable. The top circumferential edge of housing 1 can be concealed by a cover 45 mountable on pin 17 so that the circumferential side wall of housing 1 is almost completely closed and the wire (not shown) is routed into and out of wire-winding unit 50 at diametrically opposed wire inlet and wire outlet areas.

According to FIG. 1, wire-winding unit 50 includes a base referred to overall as 10 with an axial pin 11 provided on it, on which wire-winding cylinder 20 is pivotably supported. Circumferential side wall 21 and arch-shaped curved wall 24 of cylinder 20 form a cylindrical receptacle in which torsion spring 30 is accommodated. End 31 of torsion spring 30 is hooked into slot 12 of pin 11 protruding through the base of cylinder 20, the other end of torsion spring 30 bent into a lug 32 is hooked into axial cut-outs 23 of cylinder 20. The cylindrical receptacle is covered on top by a spring lid 38, radial projections 37 of which are pushed into further axial cut-outs 22 of cylinder 20. For complete closure of the cylindrical receptacle and to realize a positive fit, front edge 38 of spring lid 35 is matched to the contour of arch-shaped curved area 24 of cylinder 20. On spring lid 35 sits a locking washer 40 with an internal hole 41 which is shaped to correspond to the front free end of pin 11. By placing locking washer 40 over the front free end of pin 11, cylinder 20 with torsion spring 30 accommodated therein is secured axially, preferably essentially free from play. The axial locking referred to before can be achieved by means of hot-stamping of spring lid 35 on pin 11. As a result of the construction referred to above, wire-winding unit 50 can be pushed as a unit into housing 1 and pulled out of it again, even with cylinder 20 pretensioned, as described in the following.

According to FIG. 1, arch-shaped curved side wall 24 and circumferential side wall 25 of cylinder 20 form a wire clamping area or a wire guiding device 26 for the wire. To insert or replace the wire, cylinder 20 is brought into a rotational position in which the front or rear end respectively of aforementioned wire guiding device 26 is aligned or level with the front 15 or rear 19 wire inlet area respectively of base 10. This rotational position can be secured by a locking mechanism, as described in the following, with torsion spring 30 pretensioned. According to FIG. 1, front and rear wire inlet area 15, 19 respectively are open at the top when wire-winding unit 50 has been removed from housing 1. To insert the wire into wire-winding unit 50, the wire can thus be introduced from the top in the aforementioned rotational position of cylinder 20 and can be inserted in the wire guiding device or wire clamping area 26. In this rotational position, wire-winding cylinder 20 continues to be pretensioned by torsion spring 30 in a rotational direction in which the wire is wound up further. After releasing the locking mechanism, the wire is automatically wound on circumferential side wall 21 of cylinder 20. In this case care must be taken to ensure that the wire does not escape upwards out of wire inlet area 15, 19. This can be accomplished by placing the fingers on the upper ends of front and rear wire inlet cheeks 14, 18 respectively of base 10 when wire-winding unit 50 is not yet pushed into housing 1. According to the preferred embodiment, however, wire-winding unit 50 is initially pushed into housing 1 after replacement of the wire and then the wire is wound up automatically by releasing the locking mechanism. As can be seen from FIG. 1, front and rear wire inlet area 15, 19 is secured at the top by side cover 6 and top side 2 of the housing when wire-winding unit 50 is completely pushed into housing 1. In the fully inserted position, side cover 6 engages in tangential slot 16 formed in front wire inlet cheeks 14 in order to further secure wire-winding unit 50. Consequently, the wire cannot be replaced when wire-winding unit 50 is accommodated in housing 1.

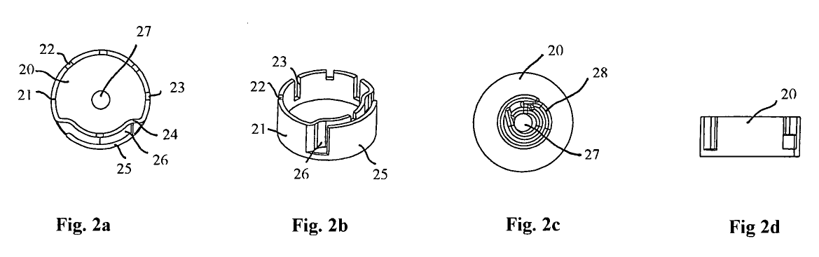

For blocking the rotary movement of cylinder 20, a ball 7 is provided which is accommodated in a radial cut-out 13 provided in the floor of base 10 and in a labyrinth-like ball guide 28 (cf. FIG. 2c) provided on the underside of cylinder 20, said ball guide being formed in a manner known from the prior art (cf. for example U.S. Pat. No. 6,803,525 B1). In this case, on winding or unwinding of the wire, the ball runs on an inner circular path of circular guide 28 whilst the ball on stopping of rotary cylinder 20 finally runs into a radial outer receptacle of ball guide 28 in order to block further rotary movement of cylinder 20. By pulling gently on the wire, the ball can be released again and transferred into the inner circular path of ball guide 28 in which cylinder 20 can be freely rotated. The locking mechanism created in this manner blocks the rotary movement of pretensioned (biased) cylinder 20 in discrete rotary positions of said cylinder predetermined by ball guide 28. In this case the locking mechanism is formed completely within wire-winding unit 50, that is, formed completely by elements of said unit, which enables replacement of the wire in the manner previously described when wire-winding unit 50 is removed from housing 1.

Of course, such a locking mechanism can also be designed in a different manner, for example as a ratchet mechanism or pawl mechanism as disclosed in U.S. Pat. No. 6,803,525. B1, as a tongue-shaped locking element which reciprocates with a circular guide formed on the cylinder as disclosed in DE 20 2004 011 010 U1 or DE 20 2004 014 202 U1, or as a guide ring structure as disclosed for example in DE 298 13 079 U1.

The contents of the printed matter cited in this paragraph are expressly included in the present application by way of reference for the purposes of disclosure.

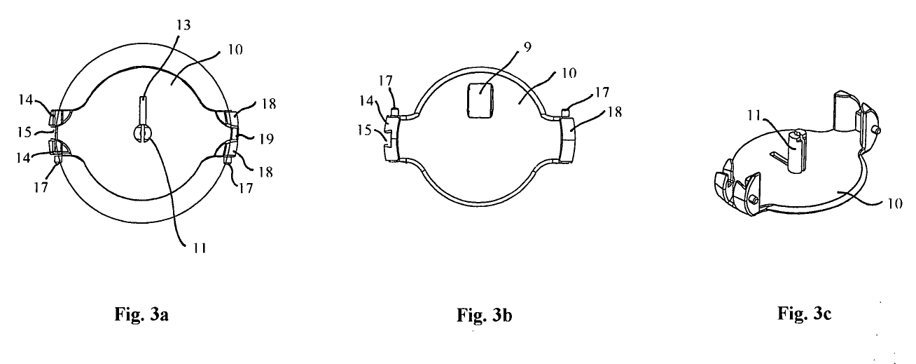

As shown in FIG. 1, on housing floor 3 is formed a projection 5 which reciprocates with a corresponding recess 9 on the underside of base 10 (cf. FIG. 3b) in order to create a latching mechanism for detachably securing of wire-winding unit 50 in housing 1. Of course, wire-winding unit 50 can also be accommodated in housing 1 in any other positive fit or force fit manner.

As can be seen from FIGS. 1 to 3c, the diameter of wire-winding cylinder 20 is smaller than the diameter of base 10. Thus the floor of base 10 forms a flange-like structure which is closed by the dome-like or hood-like curved outer circumferential edge of housing 1 when wire-winding unit 50 is accommodated in said housing 1. In this state, an annular gap is created between circumferential side wall 21 of cylinder 20 and the dome-like or hood-like curved outer circumferential edge of housing 1, said gap being ideally suited due to its shape for secure accommodation of the wire wound onto cylinder 20 without the wire twisting or tangling.

As can easily be seen from the previous description, the wire-winding unit is removed from the housing for replacement of an earphone wire. Then the wire clamping area of the wire-winding body is easily accessible so that after essentially being completely unwound the earphone wire can be removed from said area and be replaced with a different earphone wire. In the completely unwound state, the wire-winding body is locked by a locking mechanism to prevent unintentional rewinding.

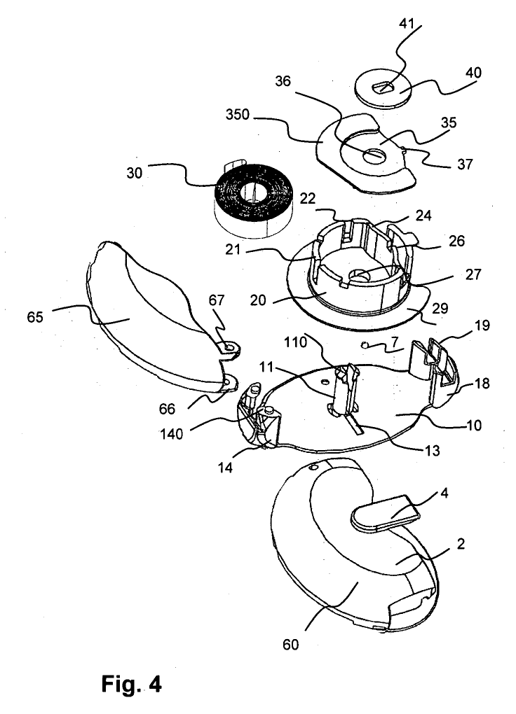

A second embodiment according to the present invention will be described in the following on the basis of FIGS. 4 to 8. According to FIG. 4, the housing comprises a large housing shell 60 and a small housing shell 65 each of which is pivotably supported on upper and lower pins 140 respectively of front wire inlet cheeks 14. On swiveling open, front wire inlet area 15 and rear wire inlet area 19 are exposed on one hand and on the other the wire-winding unit is exposed with the result that, with the earphone wire substantially completely unwound, the wire in wire clamping area 26 can be released, removed and replaced by clamping of another earphone wire. As shown in FIG. 4, two wing-like broadened sections 110 are formed on the top end of shaft 11, it being possible to move them elastically towards each other due to the longitudinal slot formed in shaft 11. By pressing sections 110 together, supported by the insertion chamfers formed on their upper side, it is possible when attaching spring lid 35 and locking washer 40 to insert sections 110 into hole 36 of spring lid 35 and into hole 41 of locking washer 40. When locking washer 40 is completely in position, sections 110 move back apart and in this way secure wire-winding cylinder 20 and torsion spring 30 axially on shaft 11. In order to guide the inserted wire more effectively a flange 29 is formed on the floor of wire-winding cylinder 20, the width of said flange corresponding in the radial direction to approximately the thickness of the wire coil in the completely wound state.

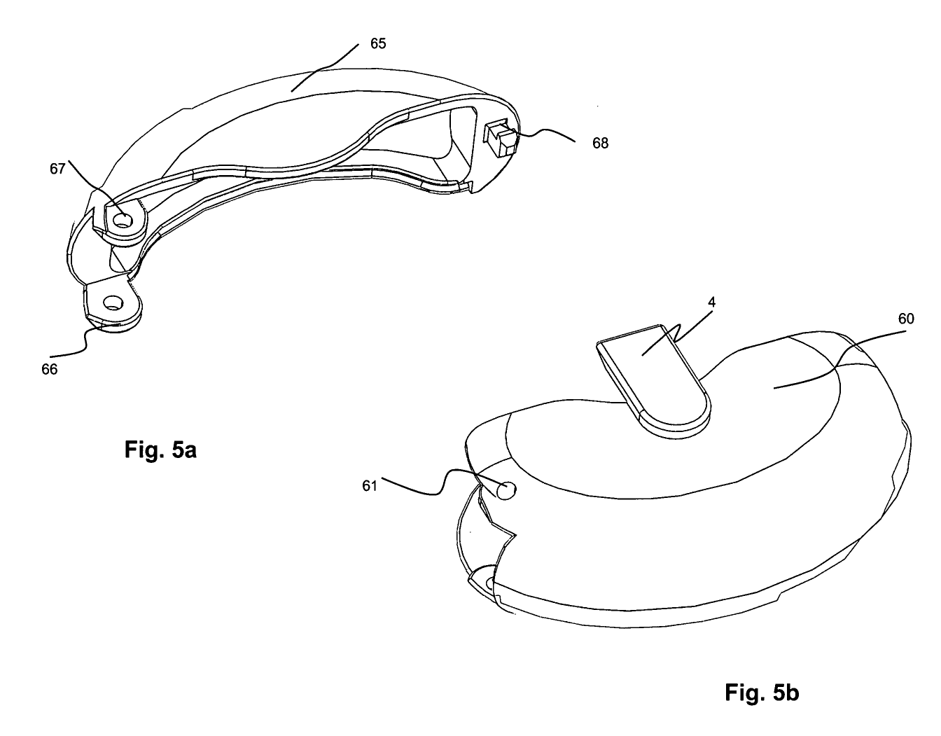

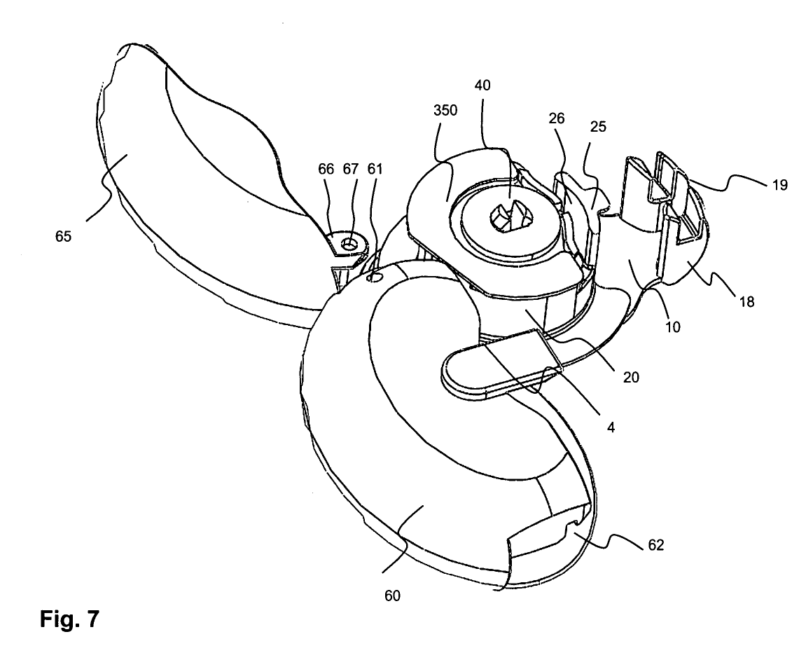

According to FIG. 5a, on small housing shell 65 are provided two tabs 66 with holes 67 or cut-outs formed therein which are hooked into pins 140 on front wire inlet cheeks 14 (cf. FIG. 4) so as to pivotably support housing shell 65 on base 10. On its diametrically opposing end an elastic snap hook 68 is formed on housing shell 65, said hook reciprocating when the housing shells are closed with a latching cut-out 62 (cf. FIG. 7) formed on large housing shell 60 in order to lock the two housing shells 60, 65 together and to hold the housing thus formed closed. According to FIG. 5b, on large housing shell 60 are formed two holes 61 or cut-outs, which are hooked into pins 140 on front wire inlet cheeks 14 (cf. FIG. 4) in order to support housing shell 60 pivotably on base 10.

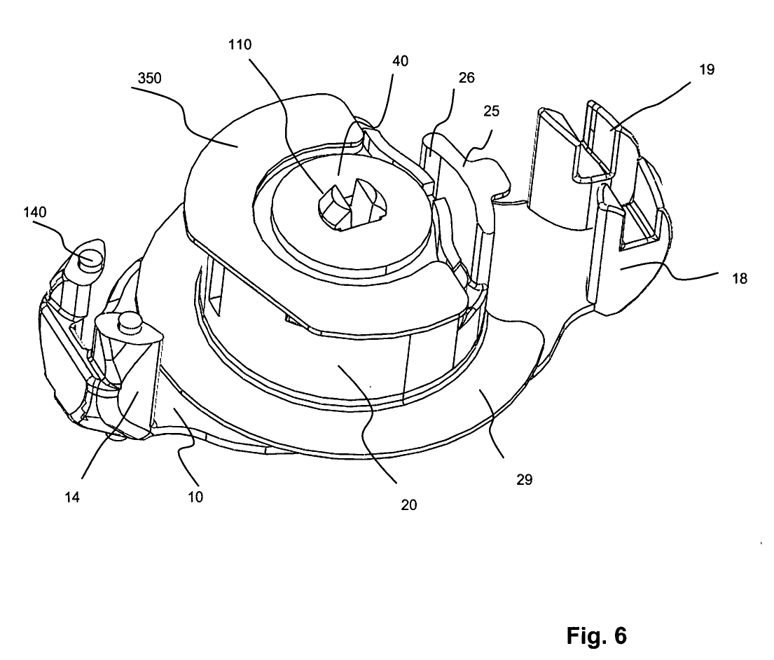

FIG. 6 shows a perspective view of wire-winding unit 50 according to the second embodiment. It is possible to identify the axial securing of the spring lid, the spring and wire-winding cylinder 20 by locking washer 40. Wire clamping area 26 is freely accessible from the top side of unit 50.

As shown in FIG. 7, the front wire inlet area, rear wire inlet area 19 and wire clamping area 26 are freely accessible from the top after sliding apart the two housing shells 60, 65. After essentially completely unwinding the earphone wire (not shown) it can be removed from wire clamping area 26 and replaced with a different earphone wire. After unwinding the wire, wire-winding cylinder 20 is locked due to the locking mechanism previously described or due to a comparable locking mechanism known from the prior art to prevent unintentional rewinding of wire-winding cylinder 20. The locking mechanism can, for example, be released by a pulling movement on the earphone wire in the direction of unwinding or other measures known from the prior art.

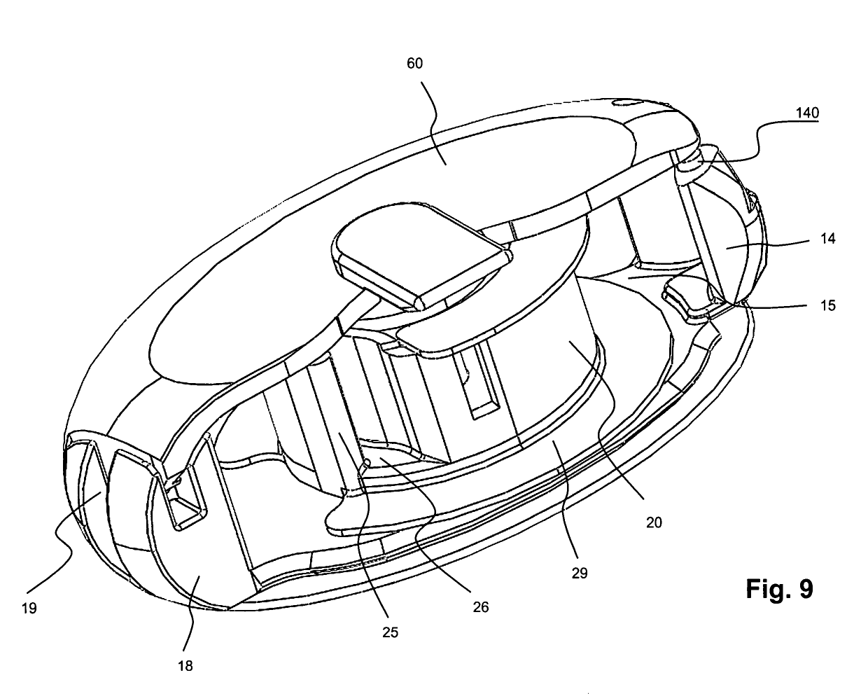

FIG. 9 clearly shows the two wire inlet areas 15, 19 and wire clamping area 26 with the wire-winding unit inserted.

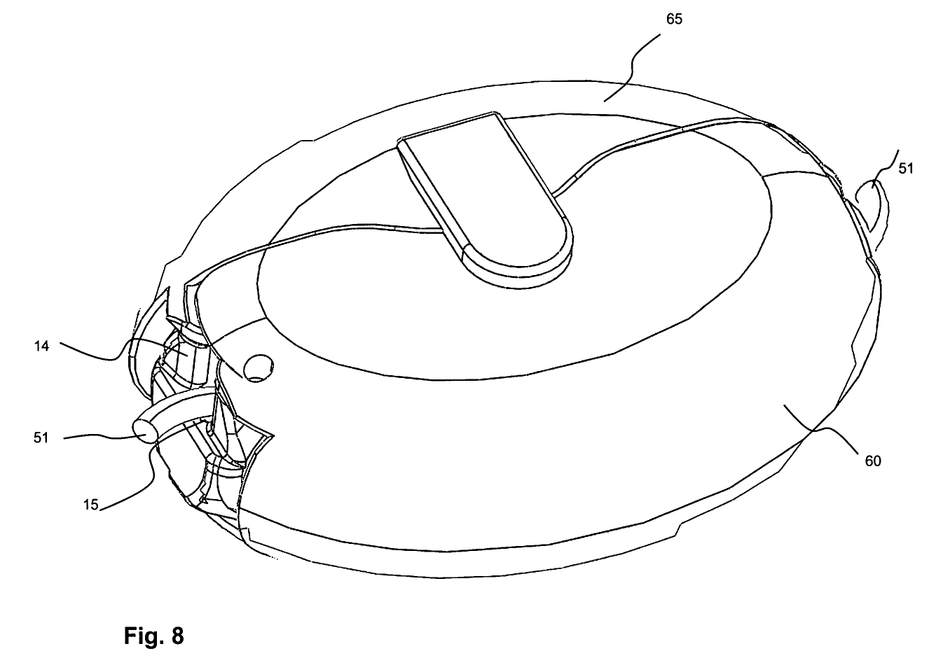

FIG. 8 shows the wire-winding device according to the second embodiment with housing shells 60, 65 closed and earphone wire 51 inserted. In this state the two-shell housing is essentially completely closed and wire 51 is reliably guided by wire inlet cheeks 14 and 18 (cf. FIG. 4).

As will be easily apparent to the person skilled in the art on studying the preceding description, the elements of the wire-winding device according to the invention can be formed precisely and inexpensively by injection molding of a suitable plastic. The outer diameter of cylindrical housing 1 depends essentially in this regard on the length of wire to be accommodated and can be approximately in the range of 4 to 6 cm for the preferred use according to the invention of winding up a hands free kit for mobile phones. In the completely wound state, essentially only the earpieces and the connector of the earphone protrude from housing 1 and in the case of being used for winding up a hands free kit for mobile phones also the microphone with retaining clip. According to a further embodiment which is not shown, retaining elements or retaining holders for temporary accommodation or securing of these elements can be provided on the housing so that such elements do not hang out of the housing in an uncontrolled manner.

What is claimed as new and is desired to be secured by Letter Patent of the United States is:

1. A wire-winding device for earphones especially for a hands free kit for mobile phones comprising
a wire-winding unit, which comprises a rotary cylindrical wire-winding body for winding up an earphone wire which is pretensioned in a direction of rotation in which the earphone wire will continue to be wound onto the wire-winding body and
a housing for accommodation of the wire-winding unit with the wound up earphone wire and the pretensioned wire-winding body,
wherein the wire-winding unit is designed such that the earphone wire is replaceable with the wire-winding body pretensioned.

2. Wire-winding device according to claim 1 wherein the wire-winding body has a wire clamping area for clamping a section of the earphone wire whereby at least one of the housing and the wire-winding unit is designed such that in a completely unwound rotary position of the wire-winding body the earphone wire can be removed from the wire clamping area and a different earphone wire can be clamped by said wire clamping area.

3. Wire-winding device according to claim 2 wherein the wire clamping area is formed by a circumferential side wall of the wire-winding body and a radially opposing, arch-shaped curved wall of the wire-winding body.

4. Wire-winding device according to claim 1 wherein the housing includes a removable cover or pivotable housing sections to expose and conceal a wire inlet area and a wire outlet area for replacement of the earphone wire.

5. Wire-winding device according to claim 1 wherein the wire-winding unit together with the pretensioned wire-winding body is accommodated in the housing so as to be movable radially, whereby replacement of the earphone wire is then prevented when the wire-winding unit is accommodated completely in the housing.

6. Wire-winding de-vice according to claim 5 wherein at least one of a wire inlet area and a wire outlet area of the wire-winding unit is formed by reciprocation of sections of said wire-winding unit and sections of the housing to permit or prevent replacement of the earphone wire.

7. Wire-winding device according to claim 1 wherein the wire-winding unit together with the pretensioned wire-winding body is completely removable from the housing for replacement of the earphone wire.

8. Wire-winding device according to claim 5 wherein a latching mechanism is provided on at least one of the housing and the wire-winding unit for detachably securing the wire-winding unit in the housing.

9. Wire-winding device according to claim 1 further including a locking mechanism for detachably locking a rotary movement of the wire-winding body in discrete or arbitrary rotary positions of the wire-winding body.

10. Wire-winding device according to claim 9 wherein the locking mechanism is formed by reciprocation of the housing with the wire-winding unit.

11. Wire-winding device according to claim 9 wherein the locking mechanism is formed completely inside the wire-winding unit.

12. Wire-winding device according to claim 11 wherein the locking mechanism is formed by a radial cut-out on a floor of the wire-winding unit and by a guide groove provided on an underside of the wire-winding unit facing the floor for guiding a ball accommodated in the radial cut-out.

13. Wire-winding device according to claim 12 wherein the locking mechanism is formed by a pawl mechanism.

14. Wire-winding device according to claim 1 wherein the wire-winding unit comprises a torsion spring for pretensioning the wire-winding body, one end of said spring being actively joined to a floor of the wire-winding unit and the other end being actively joined to the wire-winding body.

15. Wire-winding device according to claim 14 wherein the torsion spring is accommodated completely inside a cylindrical receptacle of the wire-winding body.

16. Wire-winding device according to claim 1 wherein the torsion spring is axially secured on a pin provided on the floor of the wire-winding unit.

17. Wire-winding unit according to claim 16 wherein the torsion spring is axially secured to the pin by hot stamping or latching of a locking element.

18. Wire-winding device according to claim 1 wherein retaining holders are provided for temporarily accommodating a connector or earphones or a microphone of the earphones or of the hands free kit.

19. Wire-winding device according to claim 1 wherein an outer circumferential wall of the housing is formed curved and dome-shaped or hood-shaped with the result that an annular wire receptacle for accommodating the earphone wire with a dome or hood-shaped curved outer circumference is formed between a circumferential side wall of the wire-winding body and the outer circumferential wall of the housing.
